(19) United States
(12) Patent Application Publication
(10) Pub. No.: US 2013/0328439 A1
(43) Pub. Date: Dec. 12, 2013

(54) DRIVE DEVICE

(71) Applicant: SHINANO KENSHI CO., LTD., Ueda-shi (JP)

(72) Inventors: Eiji OKADA, Nagano (JP); Kazuhiro UEDA, Nagano (JP)

(73) Assignee: SHINANO KENSHI CO., LTD., Ueda-shi (JP)

(21) Appl. No.: 13/899,924

(22) Filed: May 22, 2013

(30) Foreign Application Priority Data
Jun. 12, 2012 (JP) 2012-133167
May 2, 2013 (JP) 2013-097147

(51) Int. Cl. H02K 1/27

(52) U.S. Cl. CPC H02K 1/2786
USPC 310/216.117

(57) ABSTRACT

A drive device includes: a driven member; and an outer rotor type motor driving the driven member, wherein the outer rotor type motor comprises a rotor, the rotor includes: a rotational shaft connected to the driven member; a yoke secured to the rotational shaft; and a permanent magnet secured to the yoke, the yoke is provided with a balance portion for shifting a center of gravity of the yoke with respect to a rotational center of the yoke, and the balance portion reduces imbalance caused when the rotational shaft is rotated.

### CROSS-REFERENCE TO RELATED APPLICATION

This application is based upon and claims the benefit of priority of the prior Japanese Patent Application No. 2012-133167, filed on Jun. 12, 2012, and the prior Japanese Patent Application No. 2013-097147, filed on May 2, 2013, the entire contents of which are incorporated herein by reference.

### BACKGROUND

(i) Technical Field

The present invention relates to a drive device.

(ii) Related Art

There is known a drive device equipped with a driven member driven by a motor. For example, in a compressor and a vacuum as an example of the driven device, a piston as the driven member reciprocates within a cylinder by the motor, so intake air is compressed and discharged. Japanese Patent Application Publication No. 2007-205207 discloses such a compressor.

There is a case where a balancer is provided in such a drive device. Such a balancer is generally connected to a rotational shaft to which the driven member is connected, so that the whole size of the device might be increased.

### SUMMARY

According to an aspect of the present invention, there is provided a drive device includes: a driven member; and an outer rotor type motor driving the driven member, wherein the outer rotor type motor comprises a rotor, the rotor includes: a rotational shaft connected to the driven member; a yoke secured to the rotational shaft; and a permanent magnet secured to the yoke, the yoke is provided with a balance portion for shifting a center of gravity of the yoke with respect to a rotational center of the yoke, and the balance portion reduces imbalance caused when the rotational shaft is rotated.

### BRIEF DESCRIPTION OF THE DRAWINGS

FIG. 1 is an external view of a compressor according to a first embodiment;

FIG. 2 is an external view of the compressor according to the first embodiment;

FIG. 3A is a sectional view taken along line A-A of FIG. 1, and FIG. 3B is a sectional view taken along line B-B of FIG. 1;

FIG. 4 is a sectional view of a compressor according to a second embodiment;

FIG. 5 is a partially sectional view of a variation according to the second embodiment;

FIG. 6 is an external view of a compressor according to a third embodiment;

FIG. 7A is an external view of a compressor according to a fourth embodiment, and FIG. 7B is a partially sectional view taken along line C-C of FIG. 7A.

FIG. 8 is an external view of a compressor according to a fifth embodiment;

FIG. 9 is a sectional view taken along line D-D of FIG. 8;

FIG. 10 is a partially sectional view of a first variation according to the fifth embodiment;

FIG. 11 is a partially sectional view of a second variation according to the fifth embodiment; and

FIG. 12 is an explanatory view of a reduction machine.

### DETAILED DESCRIPTION

### First Embodiment

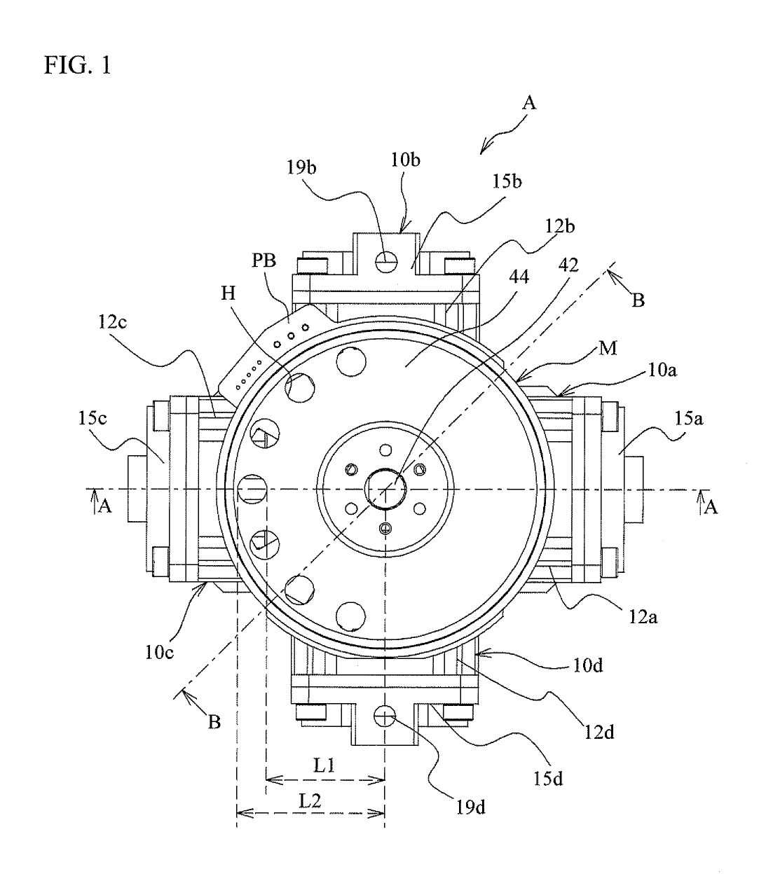

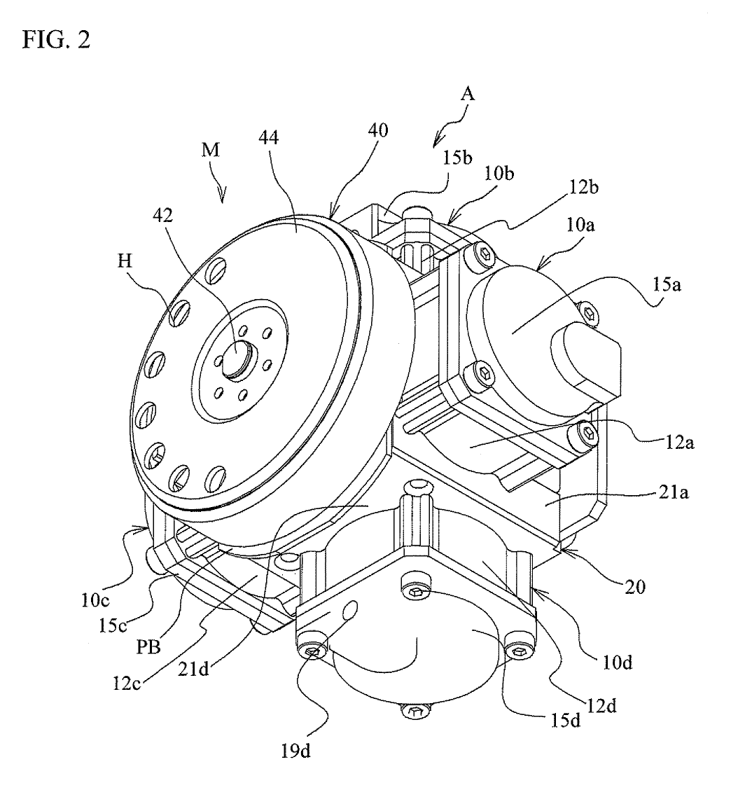

FIGS. 1 and 2 are external views of a compressor A according to a first embodiment. The compressor A is an example of an drive device. The compressor A includes: four cylinders 10a to 10d; a crankcase 20 connected with the four cylinders 10a to 10d; and a motor M arranged at the upper side of the crankcase 20. A non-illustrated fan is positioned radially outside the rotor 40, and is rotated by the rotation of the motor M. The cylinders 10a to 10d are secured around the crankcase 20. The cylinders 10a to 10d and the crankcase 20 are an example of a case housing a driven member. As illustrated in FIG. 1, the cylinders 10a to 10d are radially arranged about the rotational shaft 42 at even intervals. The rotational shaft 42 is for the motor M. The cylinder 10a includes: a cylinder body 12a secured to the crankcase 20; and a cylinder head 15a secured to the cylinder body 12a. Likewise, the other cylinders 10b to 10d have the same structure. The cylinder 10a, the crankcase 20, and the like are made of metal such as aluminum having good heat radiation characteristics.

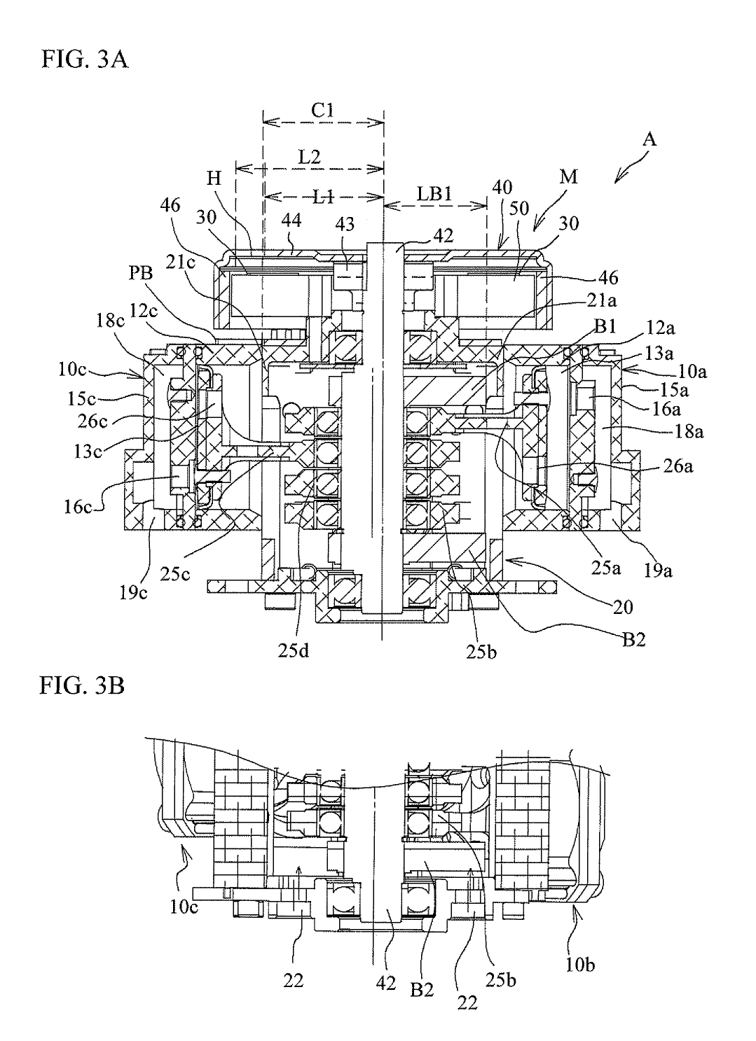

FIG. 3A is a sectional view taken along line A-A of FIG. 1. FIG. 3B is a sectional view taken along line B-B of FIG. 1. Firstly, the motor M will be described. The motor M includes coils 30, a rotor 40, a stator 50, and a printed circuit board PB. The stator 50 is made of metal. The stator 50 is secured to the crankcase 20. The plural coils 30 are wound around the stator 50. The coils 30 are electrically connected with the printed circuit board PB. As for the printed circuit board PB, conductive patterns are formed on an insulating board having rigidity. A non-illustrated power supply connector for supplying power to the coils 30, a signal connector, and other electronic parts are mounted on the printed circuit board PB. For example, the electronic part is an output transistor (a switching element) such as an FET for controlling an energized state of the coils 30, or a capacitor. The coils 30 are energized, so the stator 50 is energized.

The rotor 40 includes: a rotational shaft 42; a yoke 44; and one or plural permanent magnets 46. The rotational shaft 42 is rotationally supported by plural bearings arranged within the crankcase 20. The yoke 44 is secured to the rotational shaft 42 through a hub 43, so the yoke 44 rotates together with the rotational shaft 42. The yoke 44 has a substantially cylindrical shape and is made of metal. One or plural permanent magnets 46 are secured to the inner circumferential side of the yoke 44. The permanent magnets 46 face the outer circumferential surface of the stator 50. The coils 30 are energized, so the stator 50 is energized. Thus, the magnetic attractive force and the magnetic repulsive force are generated between the permanent magnets 46 and the stator 50. This magnetic force allows the rotor 40 to rotate with respect to the stator 50. As mentioned above, the motor M is an outer rotor type motor in which the rotor 40 rotates.

The internal structure of the cylinder 10a will be described. A chamber 13a is formed in the cylinder body 12a. The chamber 13a is defined by the space within the cylinder body 12a and a distal end of a piston 25a reciprocating within the space. The piston 25a is reciprocated by the rotation of the motor M to increase or decrease a capacity of the chamber 13a. The proximal end of the piston 25a is located in the crankcase 20, is coupled with the rotational shaft 42 of the motor M through a bearing. Specifically, the proximal end of the piston 25a is connected to the position through a bearing at a position eccentric to the center position of the rotational shaft 42. The rotation of the rotational shaft 42 in the single direction permits the piston 25a to reciprocate. Likewise, the other cylinders 10b to 10d and the other pistons 25b to 25d respectively moving therewithin have the same structure. The positional phase difference between the four pistons 25a to 25d is 90 degrees. The pistons 25a to 25d are an example of a driven member.

Plural air holes 22 are provided at the bottom portion of the crankcase 20. The reciprocation of the piston 25a permits air to be introduced into the crankcase 20 through the air holes 22. The distal end of the piston 25a is provided with a communication hole 26a. The end surface of the distal end of the piston 25a is provided with a non-illustrated valve member for opening and closing the communication hole 26a. In the cylinder head 15a, a wall portion by which the chamber 13a and an exhaust chamber 18a are separated is formed with a communication hole 16a. The communication hole 16a of the wall portion is provided with a non-illustrated valve member for opening and closing the communication hole 16a.

The reciprocation of the piston 25a changes the capacity of the chamber 13a. In response to this, air is introduced to the chamber 13a through the air holes 22 and the communication hole 26a, and is compressed within the chamber 13a. The compressed air is discharged into the exhaust chamber 18a through the communication hole 16a. An air hole 19a is provided with the exhaust chamber 18a. For example, a tube is connected to the air hole 19a. Additionally, air holes 19b and 19d are provided at the upper portions in the cylinders 10b and 10d, respectively, as illustrated in FIG. 1.

Likewise, the other cylinders 10b to 10d have the same structure. Thus, air introduced into the crankcase 20 through the air holes formed therein is compressed by the reciprocation of the pistons 25a to 25d.

As illustrated in FIG. 3, balancers B1 and B2 are arranged within the crankcase 20. The balancers B1 and B2 are connected with the rotational shaft 42 and rotate together therewith. The balancers B1 and B2 are connected with the rotational shaft 42 to sandwich the pistons 25a to 25d. The balancer B1 is positioned at the motor M side, and the balancer B2 is positioned at the side distant from the motor M. The balancer B2 is positioned between the motor M and the pistons 25a to 25d. The balancers B1 and B2 sandwich the pistons 25a to 25d. The balancer B2 is an example of a first balancer. The balancer B1 is an example of a second balancer. Also, plural holes H are formed in the yoke 44. Therefore, the rotational center position of the yoke 44 is different from the center of gravity position thereof.

Herein, when the rotational shaft 42 rotates and the pistons 25a to 25d drive, the imbalance is caused by driving the rotational shaft 42 and the pistons 25a to 25d. It is thought that this is caused by load, such as inertia force of the rotational shaft 42, and repulsive force generated by the reciprocation of the pistons 25a to 25d.

Also, as for each of the balancers B1 and B2 and the yoke 44, the rotational center position is different from the center of gravity position. Thus, the imbalance occurs when the balancers B1 and B2, and the yoke 44 rotate. The imbalance caused by the rotation of the balancers B1 and B2 and the yoke 44 is canceled by the imbalance caused by the driving of the rotational shaft 42 and the pistons 25a to 25d. The balancers B1 and B2 are the same in mass, size, and shape, but not limited to these arrangements. The balancers B1 and B2 each have a substantially fan shape.

The crankcase 20 has a substantially rectangular parallelepiped shape. The crankcase 20 includes outer wall portions 21a and 21c. Four outer wall portions are provided and are formed with openings into which the pistons are inserted, respectively. The cylinders are secured to these outer wall portions.

As indicated in FIGS. 1 to 3, the plural holes H are formed on the upper surface of the yoke 44. The plural holes H are formed at a predetermined distance from the rotational shaft 42 and are formed at even angular intervals. The plural holes H are formed along a part of the edge of the circular upper surface of the yoke 44. In other words, the plural holes H are asymmetrical with respect to the rotational shaft 42 as illustrated in FIG. 1. The holes H are formed in such a manner, so the center of gravity of the yoke 44 is shifted from the rotational shaft 42. That is, the weight of the Yoke 44 is eccentric. The holes H are an example of a balance portion for shifting the center of gravity of the yoke 44 with respect to the rotational center of the yoke 44 and for reducing the imbalance caused when the rotational shaft 42 is rotated.

Since the balancers B1 and B2 are arranged to sandwich the pistons 25a to 25d, a moment generated in the rotational shaft 42 and the pistons 25a to 25d can be suppressed. For example, in a case where the imbalance is reduced only by the balancers 51 and 52 in the conventional manner, if at least one of the balancers B1 and B2 is eliminated, downsized, or lightweight, it might be difficult to balance the moment, and the vibration might be increased.

However, since the yoke 44 has a function for reducing the imbalance, the imbalance of the total moment can be reduced, even if at least one of the balancers B1 and B2 is eliminated, downsized, or lightweight.

In the present embodiment, the yoke 44 of the motor M act as reducing the imbalance of the total moment as well as the balancers 81 and 82. Thus, at least one of the balancers B1 and B2 can be lightweight, downsized, or reduced in thickness with the imbalance of the total moment reduced. For example, the balancers B1 and B2 are reduced in thickness, which can reduce the size of the crankcase 20 housing the balancers B1 and B2, thereby reducing the whole size of the compressor A.

Also, since the yoke 44 is arranged outside the cylinders 10a to 10d and the crankcase 20, the yoke 44 can be easily replaced without disassembling the cylinders 10a to 10d or the crankcase 20. For example, in designing the compressor A, several kinds of yokes in which the holes H are different in size or in position are prepared beforehand, and the only yoke is replaced. Therefore, the suitable yoke can be found. Further, the yoke is processed to have the hole with the compressor accomplished, thereby adjusting the balance.

As illustrated in FIGS. 1 and 3, L1 indicates the minimum distance from the rotational center of the rotational shaft 42 to the hole H in the direction perpendicular to the rotational shaft 42, and L2 indicates the maximum distance from the rotational center of the rotational shaft 42 to the hole H. Also, C1 indicates the minimum distance from the rotational center of the rotational shaft 42 to the outer wall portion 21c of the crankcase 20 in the direction perpendicular to the rotational shaft 42. Further, LB1 indicates the maximum distance from the rotational shaft 42 to the outer edge of the balancer B1.

The distance L2 is greater than the distance C1. Thus, the hole H can be formed at a desired position without depending on the size of the crankcase 20, and the hole H can be formed further outward than the crankcase 20. It is therefore possible to ensure a long distance between the rotational center of the yoke 44 and the center of gravity thereof. The distance between the rotational center of the yoke 44 and the center of gravity thereof is enlarged, so the imbalance caused in rotating the yoke 44 can be increased without greatly changing the mass of the yoke 44. The amount of the imbalance of the balancers B1 and B2 can be reduced. Therefore, the balancers B1 and B2 can be reduced in weight. In response to this, the balancers B1 and B2 can be reduced in thickness or size. In addition, since the yoke 44 is formed with the holes H, the yoke 44 itself can be reduced in weight.

The plural holes H are formed on the upper surface of the yoke 44. The plural holes H are located outside the stator 50. For example, the position or the size of the hole H can be changed without depending on the size of the stator 50. Also, the plural holes H are more distant from the pistons 25a to 25d and the crankcase 20 than the stator 50.

The plural holes H may have different shapes or sizes. Also, the hole H may have an oblong shape extending in the radial direction or in the circumferential direction of the yoke 44.

Further, as illustrated in FIG. 3, at least one of the plural holes H faces the coil 30. Thus, the yoke 44 rotates to introduce air into the motor M through the holes H. This improves the heat radiation from the coils 30. Also, air, which has flowed into the motor M through the holes H, partially flows toward the cylinders 10a to 10d and the crankcase 20 through clearances between the stator 50 and the permanent magnets 46. It is therefore possible to cool the cylinders 10a to 10d and the crankcase 20 which are heated by the sliding of the pistons 25a to 25d and adiabatic compression of air.

Additionally, the motor M is an outer rotor type. Therefore, the motor M can generate a large torque, as compared with an inner rotor type motor having the same size as the motor M. This can sufficiently drive the pistons 25a to 25d.

Additionally, the object device is connected at the exhaust side of the compressor A as will be described. However, when the object device is connected at the intake side of the compressor A or when a check valve is arranged in a manner opposite to a manner of the compressor A, the compressor A acts as a vacuum machine.

Also, in another case where the compressor A is used as a vacuum machine, the object device is connected to the air hole 22. In this case, the valve member provided within the cylinder 10a may be the same as the compressor A.

The yoke 44 having the processed hole H is processed again, thereby adjusting the imbalance of the whole compressor A. For example, the hole H which has already formed may be increased in size, or another hole may be further formed. Also, it may be adjusted by securing another part to the yoke 44.

The balancers B1 and B2 are different in at least one of size, shape, a position of the center of gravity, thickness, and mass.

### Second Embodiment

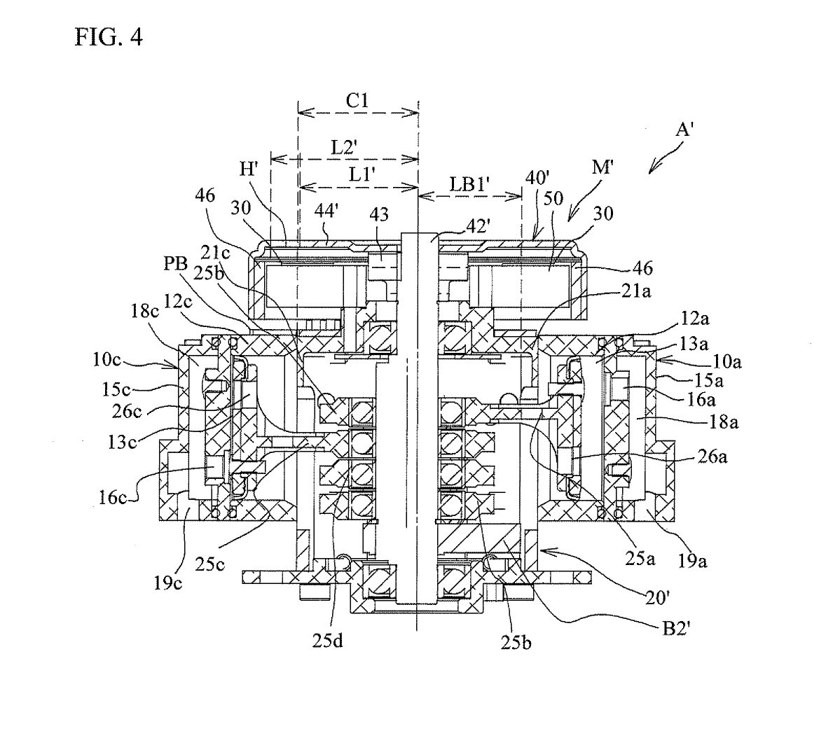

A compressor A′ according to a second embodiment will be described. Additionally, similar components of the compressor A according to the first embodiment are designated with similar reference numerals and a description of those components will be omitted. FIG. 4 is a sectional view of the compressor A′ according to the second embodiment.

A single balancer B2′ is arranged within a crankcase 20′ of the compressor A′. The mass, the shape, the size, or the like of a yoke 44′ is changed, or the size, the number, the shape, or the like of holes H′ is changed, whereby the imbalance is reduced by the single balancer B2′ and the yoke 44′. Thus, the compressor A′ is reduced in size in the direction of a rotational shaft 42′. Also, the balancer B1 is not arranged between a motor M′ and the pistons 25a to 25d, whereby lightweight is achieved.

Additionally, like the first embodiment, a distance L2′ is greater than the distance C1. The present embodiment eliminates the balancer which is arranged in the motor M side and which is connected to the upper end side of the rotational shaft 42′. However, the present invention is not limited to such a configuration. That is, a balancer may be connected to the upper end side of the rotational shaft 42′, and a balancer connected to the lower end may be eliminated.

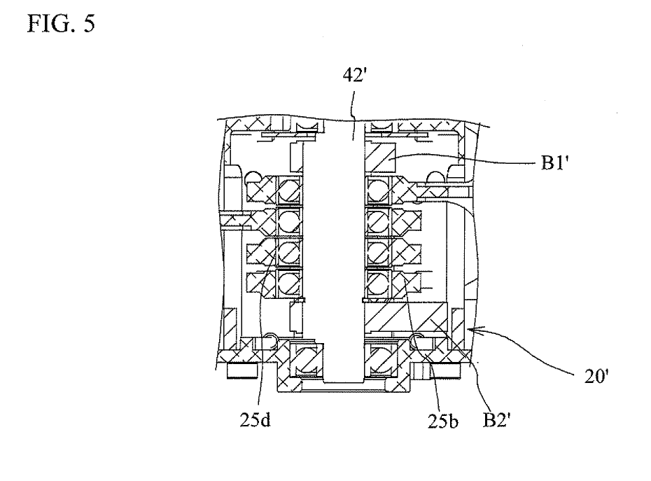

FIG. 5 is a partially sectional view of a variation according to the second embodiment. A balancer B1′ arranged at the upper end side of the rotational shaft 42′ is smaller than the balancer B2′ arranged at the lower end side thereof. Specifically, the balancers B1′ and B2′ are the same in thickness, and different in size in the radial direction. Thus, the balancers B1′ and B2′ are different in the center of gravity position. The mass, the shape, the size, or the like of the yoke 44′ is changed, or the size, the number, the shape, or the like of holes H′ is changed, whereby the imbalance is reduced by the yoke 44′, and the balancers B1′ and B2′ different in size. Also, the small balancer B1′ is employed to be lightweight.

### Third Embodiment

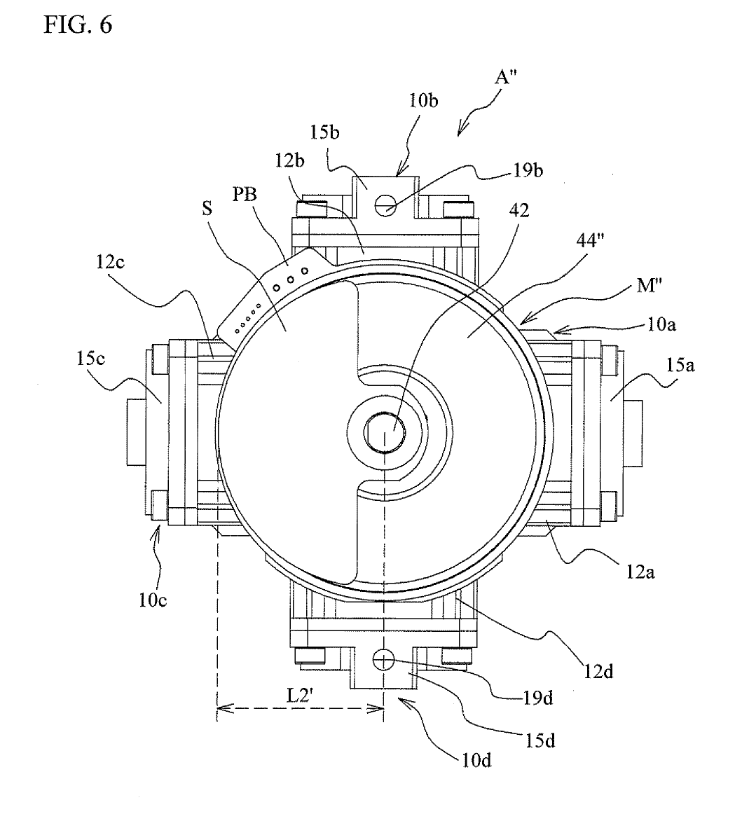

A compressor A″ according to a third embodiment will be described. Additionally, similar components of the compressor A according to the first embodiment are designated with similar reference numerals and a description of those components will be omitted. FIG. 6 is a front view of the compressor A″ according to the third embodiment.

A thin plate S is secured to a part of the upper surface of a yoke 44″. The thin plate S is made of, for example, metal. The thin plate S is provided separately from the yoke 44″. The thin plate S has a substantially fan shape. Also, unlike the first and second embodiments, the holes H are not formed in the yoke 44″. Thus, the yoke 44″ can be used as a balancer by securing the thin plate S to the yoke 44″. The thin plate S is an example of a balance portion and an example of a fixation member.

For example, in designing the compressor A″, several kinds of the thin plates S which are different in size, shape, material, or like that are prepared beforehand, and the only thin plate S is replaced with respect to the yoke 44″. Therefore, the suitable thin plate S can be found. Further, the thin plate S is replaced while assembled into the compressor, thereby adjusting the balance.

In addition, like the first and second embodiments, the maximum distance L2′ from the rotational shaft 42 to the outer edge of the thin plate S is greater than the crankcase 20. Thus, the center of gravity position of the yoke 44″ including the thin plate S can be greatly spaced from the rotational shaft 42, and the moment caused only by the rotation of the yoke 44″ can be increased.

### Fourth Embodiment

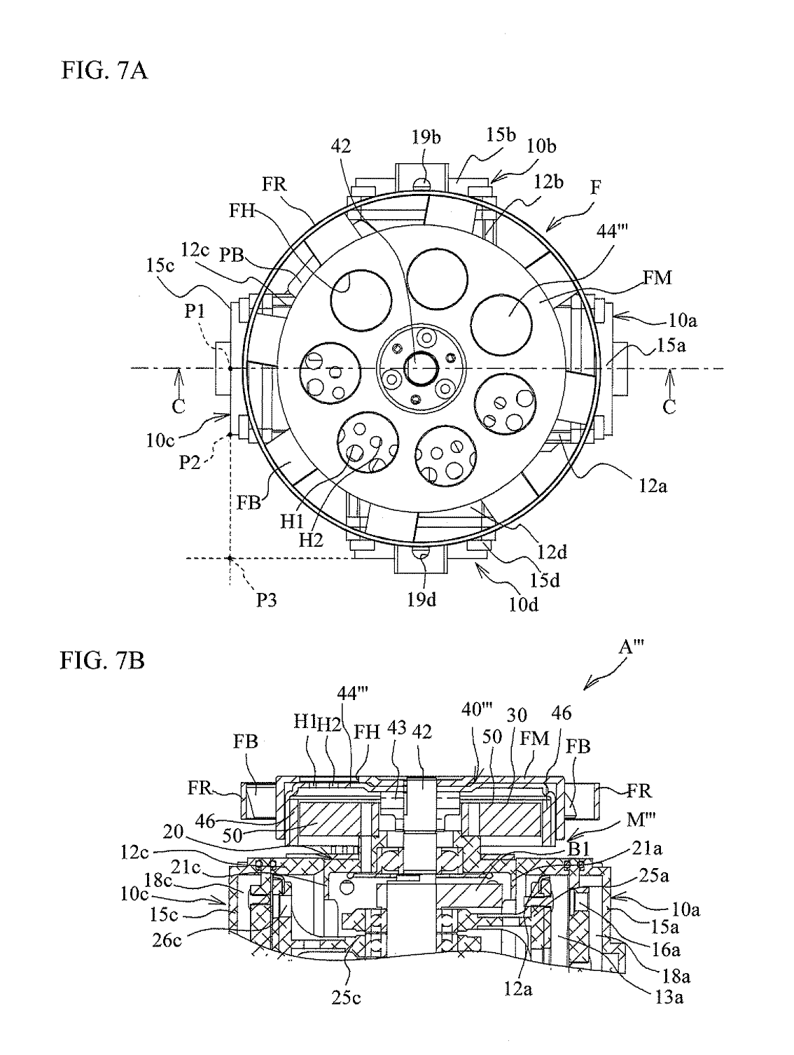

A compressor A′″ according to a forth embodiment will be described. Additionally, similar components of the compressor A according to the first embodiment are designated with similar reference numerals and a description of those components will be omitted. FIG. 7A is a front view according to the compressor A′″ according to the fourth embodiment. FIG. 7B is a sectional view taken along line C-C of FIG. 7A.

A fan F is secured to a yoke 44′″. The fan F includes: a body portion. FM having a substantially cylindrical shape; a ring portion FR formed at the outside of the body portion FM; and plural blade portions FB formed between the body portion FM and the ring portion FR. The body portion FM of the fan F is secured to the yoke 44′″ by, for example, press-fitting, adhesive bonding, or screwing a rotor 40′″ with the hub 43. Also, plural holes FH are provided in the body member FM. Therefore, the fan F is reduced in weight. The fan F is made of a synthetic resin.

The motor M′″ rotates, so the fan F rotates. Thus, the crankcase 20 and the cylinders 10a to 10d are cooled. The fan F has a size so as to face the chamber 13a of the cylinder 10a. It is possible to suppress an increase in temperature caused by adiabatic compression of air within the chamber 13a. It is also possible to suppress an increase in temperature caused by friction generated between other movable portions.

Also, the fan F is assembled into the rotor 40′″. Accordingly, the compressor A′″ is reduced in size in the direction of the rotational shaft 42, as compared with a case where a fan and the rotor 40′″ sandwich the crankcase 20. Also, the blades FB are positioned radially outside the rotor 40′″, as illustrated in FIG. 7B. In addition, the attenuation rate of the vibration of the fan F is greater than that of the rotor 40′″. It is therefore possible to reduce the drive noise of the compressor A′″. Further, the ring portion FR is provided at the ends of the plural blades FB to prevent an operator from touching the ends of the blades FB and getting injured.

The yoke 44′″ is formed with plural holes H1 and H2 which are different from each other in size. The hole H1 is larger than the hole H2. The plural holes H1 are distant from the rotational shaft 42, and the plural holes H2 are close to the rotational shaft 42. Such holes H1 and H2 act as a balance portion. Also, like the first embodiment, the holes H1 are positioned outside of the outer wall portion of the crankcase 20.

Also, the several holes FH of the fan F partially overlap the holes H1 and H2 of the yoke 44′″, so this permits air to flow into the motor M′″. This improves the heat radiation of the motor M′″. Also, this promotes cooling the crankcase 20 and the cylinders 10a to 10d. Thus, air is blown by the blades FB of the fan F and air flows through the holes FH of the fan F and the holes H1 and H2 of the yoke 44′″, so the whole compressor A′″ is cooled.

Additionally, the fan F has a size to such an extent as to partially face the cylinder heads 15a to 15d. However, the present invention is not limited to this arrangement. For example, as illustrated in FIG. 7A, the fan F may have a size to such an extent as to face the end surface (point P1) of a cylinder head 12c which is the most distant from the rotational shaft 42. Also, the fan F may have a size to such an extent as to face the corner portion (point P2) of the cylinder head 12c which is the most distant from the rotational shaft 42. Further, the fan F may have a size to such an extent as to face a position (point P3) where a virtual line passing through and parallel to one of adjacent end surfaces of the cylinder heads intersects a virtual line passing through and parallel to the other one thereof.

### Fifth Embodiment

Next, the compressor C according to a fifth embodiment will be described. Additionally, similar components of the compressor A according to the first embodiment are designated with similar reference numerals and a description of those components will be omitted.

Cylinder heads 15ac to 15dc are secured to outer circumferential wall portions 21ac to 21dc of a crankcase 20c, respectively. Cylinder bodies 12ac and 12cc are secured to the inner surfaces of the wall portions 21ac and 21cc of the crankcase 20c, respectively. When a rotational shaft 42c rotates, the distal end of the piston 25ac slides on the cylinder body 12ac. Herein, a chamber 13ac is defined by the distal end of the piston 25ac, the cylinder body 12ac, and the wall portion 21ac of the crankcase 20c. The capacity of the chamber 13ac increases and decreases by the reciprocation of the piston 25ac. Likewise, the other pistons and the other cylinder bodies are configured in the same manner.

An exhaust chamber 18ac is defined between the cylinder head 15ac and the wall portion 21ac. The chamber 13ac and the exhaust chamber 18ac are separated by the wall portion 21ac formed with a communication hole 22ac communicating the chamber 13ac with the exhaust chamber 18ac. The communication hole 22ac is opened or closed by a valve member Vac secured to the outer surface of the wall portion 21ac. Likewise, the other cylinder heads 15bc to 15dc and the other wall portions 21bc to 21dc are configured in the same manner.

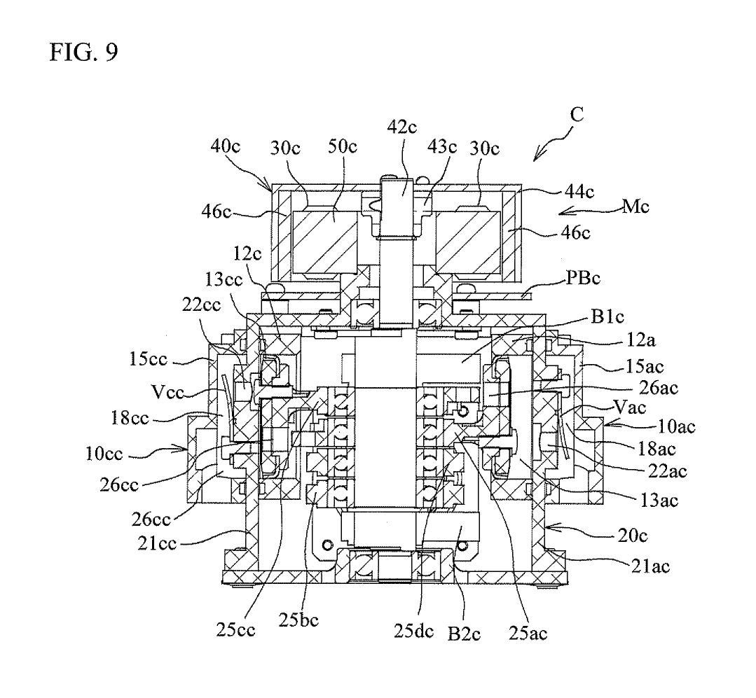

As illustrated in FIG. 9, the cylinder body 12ac is arranged within the crankcase 20c, and the wall portion 21ac of the crankcase 20c functions as a seating portion where this piston 25ac is seated. Likewise, the other wall portions 21bc to 21dc function as seating portions on which the pistons 25bc to 25dc are seated, respectively. Additionally, in order to avoid collision noise in seating the piston, a slight gap may be made so as not to seat the piston completely. Thus, the compressor c is reduced in size in such a direction that the pistons 25ac to 25dc reciprocate, that is, in the direction perpendicular to the rotational shaft 42c.

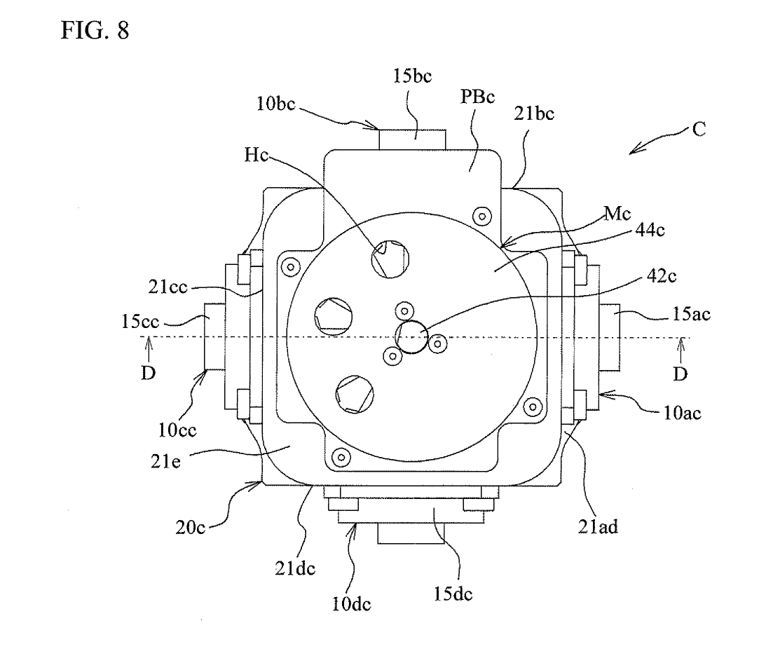

As illustrated in FIG. 8, plural holes Hc are provided in a yoke 44c. When a rotor 40c rotates, air flows into the rotor 40c through the holes Hc. Thus, a motor Mc can be cooled. Also, the plural holes Hc are asymmetric with respect to the rotational shaft 42c, and are an example of a balance portion.

As illustrated in FIGS. 8 and 9, the size of the motor Mc in the radial direction, that is, the size of the yoke 44c in the radial direction is smaller than the size of the crankcase 20c in the radial direction. Thus, even in a case where the yoke 44c is smaller than the crankcase 20c in such a manner, the holes Hc are provided to act as the balance portion.

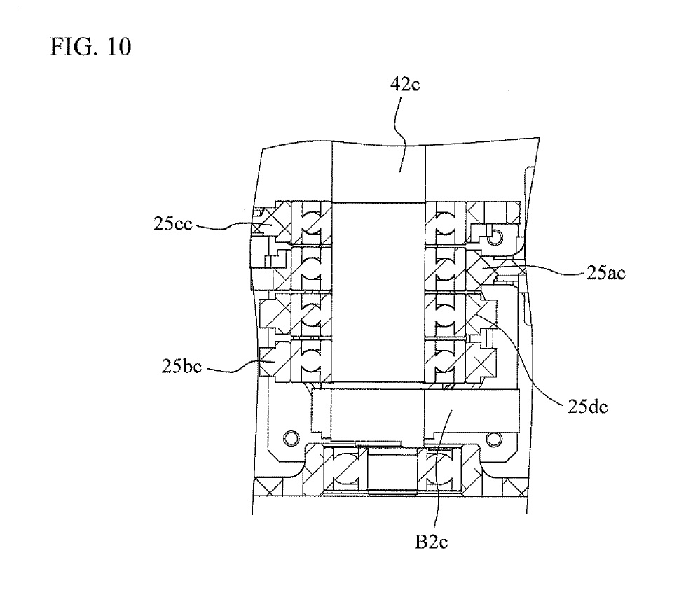

FIG. 10 is a sectional view of a first variation according to the fifth embodiment. The single balancer B2c is arranged within the crankcase 20c. The mass, the shape, the size, or the like of the yoke 44c is changed, or the size, the number, the shape, or the like of the holes Hc is changed, whereby the imbalance is reduced by the yoke 44c and the balancer B2c. Also, the balancer B1c is not arranged between the motor Mc and the pistons 25a to 25dc, whereby lightweight is achieved.

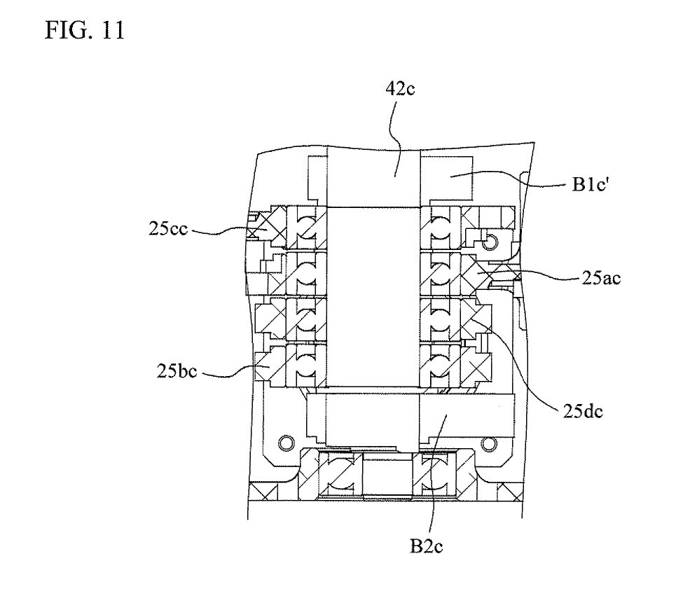

FIG. 11 is a sectional view of the second variation according to the fifth embodiment. A balancer B1c′ arranged at the upper end side of the rotational shaft 42c is smaller than the balancer B2c arranged at the lower end side thereof. Specifically, the balancers B1c′ and B2c are the same in thickness, and different in size in the radial direction. Thus, the balancers B1c′ and B2c are different in the center of gravity position. The mass, the shape, the size, or the like of the yoke 44c is changed, or the size, the number, the shape, or the like of the holes Hc is changed, whereby the imbalance is reduced by the yoke 44c and the balancers B1c′ and B2c different in size.

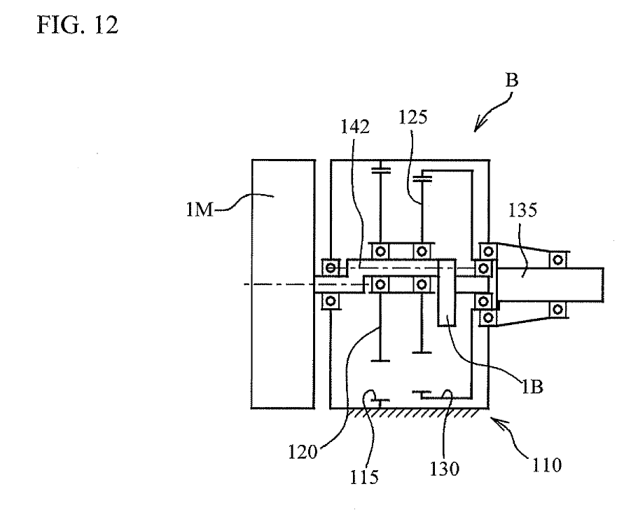

Next, a reduction machine employed in the present invention will be described. FIG. 12 is an explanatory view of the reduction machine B. Like the above mentioned motors, a motor 1M is equipped with a rotor including a yoke provided with a balance portion. When the rotor of the motor 1M rotates, a rotational shaft 142 rotates. The rotational shaft 142 extends within a case 110 facing the motor 1M. The rotational shaft 142 is eccentric within the case 110. An input disc 120 and an output disc 125 are rotatably connected to an eccentric portion of the rotational shaft 142. The input disc 120 and the output disc 125 each have a disc shape and are not each formed with teeth at the outer circumferential portion. The diameter of the input disc 120 is larger than that of the output disc 125. The case 110 is formed with an inner surface 115 on which the input disc 120 rolls. Also, an output internal disc 130 is rotatably supported within the case 110. When the output disc 125 rotates, the output internal disc 130 rotates. An output shaft 135 is connected to the output internal disc 130. When the output internal disc 130 rotates, the output shaft 135 rotates.

Within the case 110, a balancer 1B is secured to the rotational shaft 142. The size of the balancer 1B depends on the size of the case 110. However, the size of the rotor of the motor 1M does not depend on the size of the case 110. The balance portion formed in the yoke of the motor 1M and the balancer 1B adjust the imbalance in rotating the rotational shaft 142. Thus, the balancer 1B can be reduced in weight, size, or thickness. It is therefore possible to reduce the size of the case 110 and the size of the reduction machine B itself.

Additionally, the input disc 120 and the output disc 125 are an example of a driven member and a rotational member. Also, the input disc 120 and the output disc 125 may be gears which are each provided with teeth at its outer circumferential portion, the case 110 may be provided at its internal side with teeth meshing with the tooth of the input disc 120, and the output internal disc 130 may be an internal gear which is provided at its internal side with teeth.

While the exemplary embodiments of the present invention have been illustrated in detail, the present invention is not limited to the above-mentioned embodiments, and other embodiments, variations and modifications may be made without departing from the scope of the present invention.

The balance portion is not limited to the hole. The balance portion may be a thin portion which is partially thin in the upper surface of the yoke, or may be a thick portion which is partially thick therein. Also, the balance portion may be a portion whose thickness of an outer circumferential wall of the yoke secured to the permanent magnet is partially changed. The number of the cylinders is not limited to four. Also, the fan which has a difference in mass in the circumferential direction may be secured to the yoke.

In the above embodiments, the compressors, the vacuum machine, the reduction machine have been explained as an example of a drive machine. However, the drive machine is not limited to these machines. The drive machine has only to include an outer rotor type motor and a driven member driven thereby.

What is claimed is:

1. A drive device comprising:
a driven member; and
an outer rotor type motor driving the driven member,
wherein the outer rotor type motor comprises a rotor,
the rotor comprises:
a rotational shaft connected to the driven member;
a yoke secured to the rotational shaft; and
a permanent magnet secured to the yoke,
the yoke is provided with a balance portion for shifting a center of gravity of the yoke with respect to a rotational center of the yoke, and
the balance portion reduces imbalance caused when the rotational shaft is rotated.

2. The drive device of claim 1, comprising a case housing the driven member,
wherein the rotational shaft extending within the case, and
the yoke is positioned outside the case.

3. The drive device of claim 1, wherein the balance portion is positioned outside a stator of the outer rotor type motor, and is more distant from the driven member than the stator.

4. The drive device of claim 2, comprising a first balancer positioned within the case and connected to the rotational shaft,
wherein the driven member is positioned between the first balancer and the outer rotor type motor.

5. The drive device of claim 4, comprising a second balancer positioned within the case and connected to the rotational shaft,
wherein the drive member is positioned between the first and second balancers.

6. The drive device of claim 5, wherein the first and second balancers are different in at least one of size, shape, and mass.

7. The drive device of claim 2, wherein a maximum distance from the rotational shaft to the balance portion in a direction perpendicular to the rotational shaft is greater than a minimum distance from the rotational shaft to an outer wall of the case in the direction.

8. The drive device of claim 4, wherein a maximum distance from the rotational shaft to the balance portion in a direction perpendicular to the rotational shaft is greater than a maximum distance from the rotational shaft to an outer edge of the first balancer.

9. The drive device of claim 1, wherein the balance portion is a hole.

10. The drive device of claim 9, wherein the hole comprises a plurality of holes which are asymmetric with respect to the rotational shaft.

11. The drive device of claim 10, wherein
the outer rotor type motor comprises a coil, and
the hole moves above the coil, when the yoke rotates.

12. The drive device of claim 1, wherein the balance portion is a fixation member secured to the yoke and separately provided from the yoke.

13. The drive device of claim 1, comprising a fan secured to the yoke.

14. The drive device of claim 1, wherein the case includes a cylinder and a crankcase, and
the driven member is a piston reciprocating and is arranged within the cylinder and the crankcase.

15. The drive device of claim 1, wherein the drive device is a compressor or a vacuum machine.

16. The drive device of claim 1, wherein the drive device is a reduction machine.
